(19) United States
(12) Patent Application Publication
(10) Pub. No.: US 2007/0067246 A1
(43) Pub. Date: Mar. 22, 2007

(54) Authorization identification and management system and method of using the same

(76) Inventor: Jung-Bang Wang, Linkou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,312

(22) Filed: Jan. 6, 2006

(30) Foreign Application Priority Data
Sep. 16, 2005 (TW) 94132102

(51) Int. Cl. G06Q 99/00

(52) U.S. Cl. 705/59

(57) ABSTRACT

An authorization identification and management system includes a code-producing unit, a code database unit and an audit unit. The code-producing unit produces a plurality of sets of predetermined code to authorize a licensee. Each set of predetermined code is disposed on a corresponding product. The code database unit stores each set of the predetermined code that have been licensed to the licensee, so as to manage product quantities that have been licensed, and to calculate royalties that should be charged from the licensee. The audit unit judges whether the products are licensed by comparing each two sets of the predetermined code that have been respectively stored in the code database unit and have been disposed on the corresponding product. Whereby, the system does not merely make authorizing and authenticating genuine products more efficient, but it is also convenient for a right holder to calculate their total owed royalties.

### BACKGROUND OF THE INVENTION

1. Field of The Invention

The present invention relates to an authorization identification and management system and a method of using the same, and particularly relates to a system that stores a set of predetermined code that have been allocated to a licensee in a code database unit, for calculating a total amount of royalties that should be charged from the licensee. Moreover, the present invention particularly relates to judging whether products have been properly licensed via an audit unit mating with a code data base unit.

2. Description of the Related Art

A product that has been properly licensed needs to meet two conditions, including (1) the product has been licensed to allow manufacturing, and (2) a licensee has paid royalty fees for the product. However, under the lure of benefit, a lot of illegal manufacturers produce many products that encroach upon the legal rights of a patent holder. Also, some manufacturers that have obtained a license to manufacture a product utilize the license to cover up illegal behavior and evade paying royalty fees to the right holder. These encroachments upon licensed products have made the normal market circulation of commodities suffer greatly, especially licensees that have spent a large amount of manpower and financial resources in creating a fine brand. Moreover, because of the progress and development of science and technology, counterfeiters can often easily produce something that is faked but looks like the genuine article. Hence, a lot of anti-falsification technology is actually useless in identifying whether an article is genuine or not.

In order to solve the problem of products being counterfeited, it is important to improve anti-falsification technology. Many kinds of anti-counterfeit tags have already been disclosed in prior art, such as laser holographs, fluorescent ink, or variable ink, etc. However, the greatest problem of current anti-falsification technology is that if consumers want to distinguish between genuine and fake goods, they must rely on a corresponding equipment or tool to help them make that distinction. As stated, with the development of science and technology, counterfeiters can make anti-counterfeit tags that are faked but look genuine. Therefore, it is difficult to stop imitations and the encroachment upon licensed products.

Moreover, in regard to current anti-counterfeit methods, some people arrange digital data or bar codes on a product via etching or printing methods. Other people arrange digital data behind an anti-counterfeit tag and then attach the anti-counterfeit tag on the product. Hence, anyone can read the anti-counterfeit tag that is arranged on the product or the packaging of the product, either by simply looking at it, or by using a reader, to identify whether the product is genuine or fake and whether the product manufacturer has obtained a license or not. However, the above-mentioned current anti-counterfeit methods can only distinguish whether the product in question is licensed or not. They are unable to calculate the total number of products that have been manufactured and sold, or calculate the total royalties that the licensee needs to pay to the right holder. Furthermore, they are unable to provide information to a patent holder regarding how much money is owed to the right holder. Moreover, there are some shortcomings in the prior art, such as it is usually difficult for people other than the right holder or a licensee to distinguish between genuine or fake products simply by examining an anti-counterfeit tag, and the anti-counterfeit tag themselves are expensive to manufacture and purchase.

### SUMMARY OF THE INVENTION

The present invention provides an authorization identification and management system and a method of using the same. The system includes a code-producing unit for producing a plurality of sets of license code according to different products of a patent holder, and producing a plurality of sets of royalty code according to different licensees. In addition, each set of license code comprises a product code for classifying different products, and a random control code for calculating total quantities of different products. And, each product code belonging to each product has a corresponding royalty rate. In addition, each set of royalty code comprises a licensee's name for classifying different licensees, and a random control code for calculating the total number of products that are made by different licensees.

A first aspect of the present invention is an authorization identification and management system, which comprises a code-producing unit, a code database unit and an audit unit. The code-producing unit is used to product a plurality of sets of predetermined code to authorize at least one licensee, wherein each set of predetermined code is disposed on a corresponding product. The code database unit is used to store each set of predetermined code that have been licensed to the licensee, so as to manage product quantities that have been licensed, and to calculate royalties that should be charged from the licensee. And, the audit unit is used to judge whether the products are licensed by comparing with each two sets of the predetermined code that have been respectively stored in the code database unit and have been disposed on corresponding product.

Moreover, the code-producing unit is a license code/royalty code-producing unit for producing a plurality of sets of license code according to different products of a patent holder, and producing a plurality of sets of royalty code according to different licensees. In addition, each set of license code corresponds to one set of royalty code, and each set of license code and each set of royalty code are combined together for producing a set of corresponding only license code (L code+R code).

Furthermore, each set of license code comprises a product code for classifying different products, and a random control code for calculating total quantities of different products. In addition, each set of royalty code comprises a licensee code for classifying different licensees, and a random control code for calculating the total number of products that are made by different licensees.

A second aspect of the present invention is a method of using an authorization identification and management system. The method comprises: providing a code-producing unit, for producing a plurality of sets of predetermined code to authorize at least one licensee, wherein each set of predetermined code is disposed on corresponding products; providing a code database unit, for storing each set of predetermined code that have been licensed to the licensee, so as to manage product quantities that have been licensed, and to calculate royalties that should be charged from the licensee; and providing an audit unit, for judging whether the products are licensed by comparing with each two sets of predetermined code that are respectively stored in the code database unit and have been disposed on a corresponding product.

Furthermore, when the products pass through a customs office, an auditor uses the audit unit to judge whether the products have been licensed and the licensee has paid the total royalty. In addition, when the products are put on a shelf to be sold, a salesperson uses the audit unit to judge whether the products have been licensed and the licensee has paid the total royalty.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block diagram of an authorization identification and management system according to the present invention;

FIG. 2 is a coding schematic view of a license code and a royalty code according to the present invention; and

FIG. 3 is a flowchart of a method of using an authorization identification and management system according to the present invention.

### DETAILED DESCRIPTION OF PREFERRED BEST MOLDS

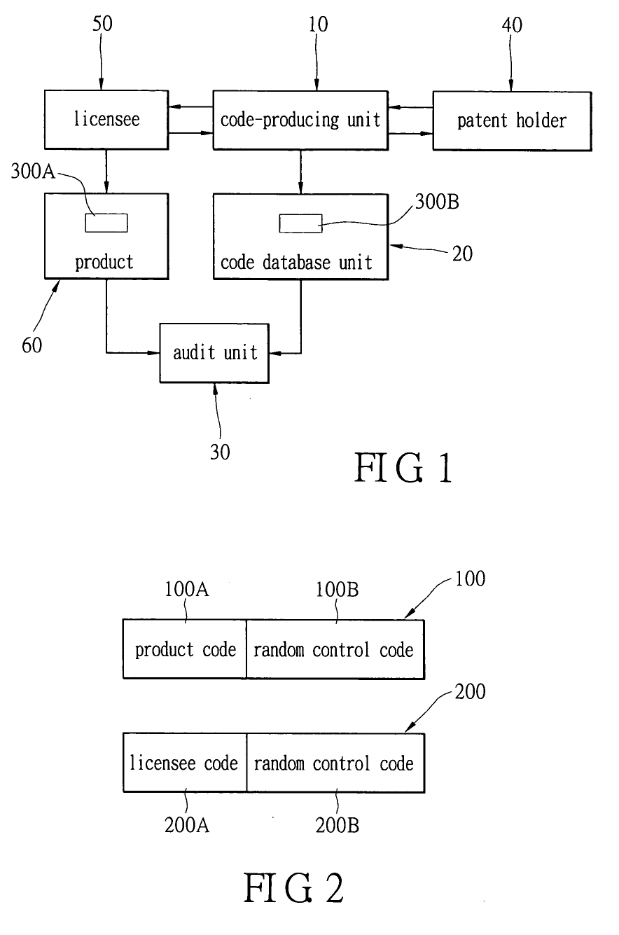

FIGS. 1 and 2 show a function block diagram of an authorization identification and management system, and a coding schematic view of a license code and a royalty code according to the present invention, respectively. The present invention provides an authorization identification and management system, which comprises a code-producing unit 10, a code database unit 20 and an audit unit 30.

Moreover, the code-producing unit 10 can be a license code/royalty code-producing unit for producing a plurality of sets of license code according to different products of a patent holder 40, and producing a plurality of sets of royalty code according to different licensees 50. In addition, each license code and each royalty code are set according to the above-mentioned conditions.

Furthermore, the code-producing unit 10 is used to produce a plurality of sets of predetermined code to authorize at least one licensee 50, and each set of predetermined code is disposed on a corresponding product 60. The code database unit 20 is used to store each set of the predetermined code that have been licensed to the licensee 50, so as to manage product quantities that have been licensed, and to calculate royalties that should be charged from the licensee 50. In addition, the audit unit 30 is used to judge whether the products are licensed by comparing each two sets of the predetermined code that have been respectively stored in the code database unit 20 and have been disposed on the corresponding product 60.

Referring to FIG. 2, each set of license code 100 comprises a product code 100A for classifying different products, and a random control code 100B for calculating total quantities of different products. Furthermore, each product code belonging to a different product has a corresponding royalty rate. In addition, each set of royalty code 200 comprises a licensee code 200A for classifying different licensees, and a random control code 200B for calculating total numbers of products that are manufactured by different licensees.

Moreover, each set of license code (L code) 100 corresponds to one set of royalty code, and each set of license code and each set of royalty code (R code) 200 are combined together for producing a set of corresponding single legal authorization code (L code+R code) 300A that is disposed on the corresponding product 60. In other words, each set of corresponding single legal authorization code (L code+R code) 300A is disposed on the corresponding product 60 according to different products and different licensees. Hence, the right holder 40 will know the license status by the single legal authorization code (L code+R code) 300A.

Furthermore, the code database unit 20 is used to store each set of the single legal authorization code (L code+R code) 300B that have been licensed to the licensee 50, so as to manage product quantities that have been licensed, and to calculate royalties that should be charged from the licensee 50. In addition, there are some auditing methods by using the audit unit 30, as follows:

(1) The audit unit 30 is a wireless reader with product auditing/comparing program for scanning the set of single legal authorization code (L code+R code) 300A that is disposed on the corresponding product 60;

(2) The audit unit 30 is an auditing/comparing device with a product auditing/comparing program, and the set of single legal authorization code (L code+R code) 300A disposed on the corresponding product 60 is keyed-in into the auditing/comparing device; and

(3) The audit unit 30 is a computer that communicates with the code database unit 20 through the Internet, and auditor can use the computer to communicate with the stored code data base unit 20.

Hence, the present invention can use the above-mentioned three auditing methods for judging whether the set of single legal authorization code (L code+R code) 300A disposed on the corresponding product 60 is the same as the single legal authorization code (L code+R code) 300B downloaded from the code database unit 20, or for judging whether the license code 100 and the royalty code 200 of the set of single legal authorization code (L code+R code) 300A correspond.

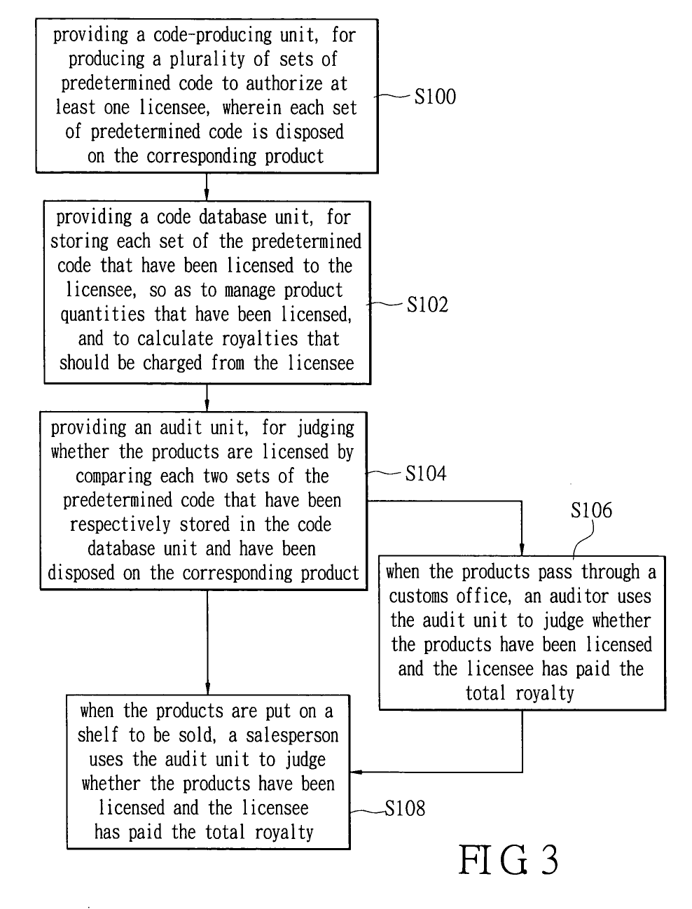

FIG. 3 shows a flowchart of a method of using an authorization identification and management system according to the present invention. The present invention provides a method of using an authorization identification and management system. The method comprises: firstly, providing a code-producing unit 10, for producing a plurality of sets of predetermined code to authorize at least one licensee 50, wherein each set of predetermined code is disposed on the corresponding product (S100); next, providing a code database unit 20, for storing each set of the predetermined code that have been licensed to the licensee 50, so as to manage product quantities that have been licensed, and to calculate royalties that should be charged from the licensee 50 (S102); and providing an audit unit 30, for judging whether the products are licensed by comparing each two sets of the predetermined code that have been respectively stored in the code database unit 20 and have been disposed on the corresponding product 60 (S104).

Afterward, when the products pass through a customs office, an auditor uses the audit unit 30 to judge whether the products have been licensed and the licensee has paid the total royalty (S106). Next, when the products are put on a shelf to be sold, a salesperson uses the audit unit 30 to judge whether the products have been licensed and the licensee has paid the total royalty (S108). Alternatively, if the products do not need to pass through a customs office, step of S108 is executed after step of S104.

Moreover, the code-producing unit 10 can be a license code/royalty code-producing unit for producing a plurality of sets of license code according to different products of a patent holder 40, and producing a plurality of sets of royalty code according to different licensees 50. In addition, each set of license code 100 comprises a product code 100A for classifying different products, and a random control code 100B for calculating total quantities of different products. Furthermore, each product code belonging to a different product has a corresponding royalty rate. In addition, each set of royalty code 200 comprises a licensee code 200A for classifying different licensees, and a random control code 200B for calculating the total number of products that are made by different licensees.

Moreover, each set of license code (L code) 100 corresponds to one set of royalty code, and each set of license code and each set of royalty code (R code) 200 are combined together for producing a set of corresponding single legal authorization code (L code+R code) 300A that is disposed on the corresponding product 60. In other words, each set of corresponding single legal authorization code (L code+R code) 300A is disposed on the corresponding product 60 according to different products and different licensees. Hence, the right holder 40 will know the license status through the single legal authorization code (L code+R code) 300A.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An authorization identification and management system, comprising:
a code-producing unit, for producing a plurality of sets of predetermined code to authorize at least one licensee, wherein each set of predetermined code is disposed on a corresponding product;
a code database unit, for storing each set of the predetermined code that have been licensed to the licensee, so as to manage product quantities that have been licensed, and to calculate royalties that should be charged from the licensee; and
an audit unit, for judging whether the products are licensed by comparing with each two sets of the predetermined code that have been respectively stored in the code database unit and have been disposed on the corresponding product.

2. The authorization identification and management system as claimed in claim 1, wherein the code-producing unit is a license code/royalty code-producing unit for producing a plurality of sets of license code according to different products of a right holder, and producing a plurality of sets of royalty code according to different licensees.

3. The authorization identification and management system as claimed in claim 2, wherein each set of license code corresponds to one set of royalty code, and each set of license code and each set of royalty code are combined together for producing a set of corresponding single legal authorization code (L code+R code).

4. The authorization identification and management system as claimed in claim 2, wherein each set of license code comprises a product code for classifying different products, and a random control code for calculating total quantities of different products.

5. The authorization identification and management system as claimed in claim 4, wherein each product code of each different product has a corresponding royalty rate.

6. The authorization identification and management system as claimed in claim 2, wherein each set of royalty code comprises a licensee code for classifying different licensees, and a random control code for calculating a total number of products that are made by different licensees.

7. The authorization identification and management system as claimed in claim 1, wherein the audit unit is a wireless reader with product auditing/comparing program for judging whether each two sets of the predetermined code that are respectively disposed on the corresponding product and are downloaded from the stored code database unit, are the same or not via the wireless reader scanning the sets of predetermined code that are disposed on the corresponding products.

8. The authorization identification and management system as claimed in claim 1, wherein the audit unit is an auditing/comparing device with a product auditing/comparing program for judging whether each two sets of the predetermined code that are respectively disposed on the corresponding product and are downloaded from the stored code database unit, are the same or not via keying-in the sets of predetermined code that are disposed on the corresponding products into the auditing/comparing device.

9. The authorization identification and management system as claimed in claim 1, wherein the audit unit is a computer that communicates with the stored code database unit through the Internet for an auditor to judge whether each two sets of the predetermined code that are respectively disposed on the corresponding product and are downloaded from the stored code database unit, are the same or not by Internet access.

10. The authorization identification and management system as claimed in claim 1, wherein each set of predetermined code is disposed on the corresponding product according to different products and different licensees.

11. A method of using an authorization identification and management system, comprising:
providing a code-producing unit, for producing a plurality of sets of predetermined code to authorize at least one licensee, wherein each set of predetermined code is disposed on the corresponding product;
providing a code database unit, for storing each set of the predetermined code that have been licensed to the licensee, so as to manage product quantities that have been licensed, and to calculate royalties that should be charged from the licensee; and
providing an audit unit, for judging whether the products are licensed by comparing with each two sets of the predetermined code that have been respectively stored in the code database unit and have been disposed on the corresponding product.

12. The method as claimed in claim 11, wherein the code-producing unit is a license code/royalty code-producing unit for producing a plurality of sets of license code according to different products of a right holder, and producing a plurality of sets of royalty code according to different licensees.

13. The method as claimed in claim 12, wherein each set of license code corresponds to one set of royalty code, and each set of license code and each set of royalty code are combined together for producing a set of corresponding single legal authorization code (L code+R code).

14. The method as claimed in claim 12, wherein each set of license code comprises a product code for classifying different products, and a random control code for calculating total quantities of different products.

15. The method as claimed in claim 12, wherein each set of royalty code comprises a licensee code for classifying different licensees, and a random control code for calculating the total number of products that are made by different licensees.

16. The method as claimed in claim 11, wherein each set of predetermined code is disposed on the corresponding product according to different products and different licensees.

17. The method as claimed in claim 11, wherein when the products pass through a customs office, an auditor uses the audit unit to judge whether the products have been licensed and the licensee has paid the total royalty.

18. The method as claimed in claim 11, wherein when the products are put on a shelf to be sold, a salesperson uses the audit unit to judge whether the products have been licensed and the licensee has paid the total royalty.
